(19) United States
(12) Patent Application Publication
(10) Pub. No.: US 2011/0085032 A1
(43) Pub. Date: Apr. 14, 2011

(54) MICROSCOPE CAMERA AND MOBILE TERMINAL HAVING THE SAME

(75) Inventor: Mingyu Kim, Seoul (KR)

(73) Assignee: LG INNOTEK CO., LTD., Seoul (KR)

(21) Appl. No.: 12/898,814

(22) Filed: Oct. 6, 2010

(30) Foreign Application Priority Data
Oct. 6, 2009 (KR) 10-2009-0094755

(51) Int. Cl. H04N 7/18

(52) U.S. Cl. 348/79; 348/E07.085

(57) ABSTRACT

Disclosed is a microscope camera and a mobile terminal using the same, wherein the camera includes a lens unit including a plurality of lenses for enlarging an object, an illumination unit for illuminating the object, a camera module configured to receive an enlarged light image of an object from the lens unit, convert the image to an electrical signal and convert the electrical signal to a DC data, and an interface unit configured to connect the camera module to a mobile terminal for transmitting the DC data to the mobile terminal, whereby an image of an enlarged object can be outputted to a display unit of the mobile terminal or a desired image can be captured, thereby enhancing an excellent portability and mobility.

### CROSS-REFERENCE TO RELATED APPLICATION

This application claims the benefit under 35 U.S.C. §119 of Korean Patent Application No. 10-2009-0094755, filed Oct. 6, 2009, which is hereby incorporated by reference in its entirety.

### BACKGROUND OF THE DISCLOSURE

1. Field of the Invention

The present disclosure relates to a microscope camera and a mobile terminal having the same.

2. Description of Related Art

Generally, a microscope is a kind of a magnifying glass capable of seeing a small object by enlarging the same. The microscope is generally equipped with a reflective minor configured to reflect light incident on an object from outside to a light collecting lens. The microscope is utilized for observing a microorganism that requires fine observation and a fine structure of a semiconductor integrated circuit that cannot be discerned with the naked eye. The microscope is also used for various other fields such as material engineering and medical fields.

Recently, a microscope camera is provided to check an object (test object) with the naked eye and to check the object by connecting a display device such as, but not limited thereto, a computer monitor, a TV or a printer.

The microscope camera can capture a still object or a living microorganism, observe a continuous operation change through a display device, and store/manage the captured object or microorganism in a data.

However, the microscope camera is disadvantageous in that it is difficult to install a computer monitor or a TV set on which an image captured through the microscope camera is to be checked due to restraint on installation and bulkiness, and it is uncomfortable to carry the computer monitor or the TV set, leading to decreased mobility.

### BRIEF SUMMARY

The present disclosure is to provide a microscope camera having an excellent portability and mobility that is configured to output an image of an enlarged object or to capture a desired image by connecting the camera to a mobile terminal.

The present disclosure is to provide a mobile terminal formed with a microscope camera configured to enhance the function of the mobile terminal by connecting the microscope camera to the mobile terminal.

Technical subjects to be solved by the present disclosure are not restricted to the above-mentioned problems, and any other technical problems not mentioned so far will be clearly appreciated from the following description by skill in the art.

In one general aspect of the present disclosure, a microscope camera is provided, the camera comprising: a lens unit including a plurality of lenses for enlarging an object; an illumination unit for illuminating the object; a camera module configured to receive an enlarged light image of an object from the lens unit, convert the image to an electrical signal and convert the electrical signal to a DC data; and an interface unit configured to connect the camera module to a mobile terminal for transmitting the DC data to the mobile terminal.

In some exemplary embodiments of the present disclosure, the camera module may include an infra-red filter configured to interrupt an infra-red from the enlarged image of the object and to send an infra-red interrupted optical image to an image sensor, the image sensor configured to convert the infra-red interrupted optical image to an electrical signal, and a slave controller configured to convert the electrical signal of the image sensor to a DC data and to send the DC data to a mobile terminal.

In some exemplary embodiments of the present disclosure, the interface unit may be a USB interface configured to be connected to the mobile terminal via a USB (Universal Serial Bus) cable.

In some exemplary embodiments of the present disclosure, the slave controller may be a USB slave controller configured to output a USB slave mode signal and convert a parallel data to a series data.

In some exemplary embodiments of the present disclosure, the camera module may include at least one of a power controller configured to supply a power to the camera module or control the power supply, a synchronized signal generator configured to generate a synchronized signal, and memory configured to store an image data digitalized by the image sensor or the parallel data converted by the slave controller.

In some exemplary embodiments of the present disclosure, the mobile terminal may receive a USB slave mode signal from the camera module, store, manipulate or display the signal through a display unit.

In some exemplary embodiments of the present disclosure, the mobile terminal may be a PCS (Personal Communication System), a GSM (Global System for Mobile communication), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), and a Wibro (Wireless Broadband Internet).

In some exemplary embodiments of the present disclosure, the illumination unit may include at least one LED (Light Emitting Diode).

In some exemplary embodiments of the present disclosure, the camera further comprises an image capture button capable of capturing an object.

In another general aspect of the present disclosure, a mobile terminal having a microscope camera is provided, the mobile terminal comprising: a body; a display unit configured to display information on the body; and a microscope camera connected to the body via a connection cable for allowing an enlarged image of the object to be displayed on the display unit or capturing an object image.

In some exemplary embodiments of the present disclosure, the body may include at least one of a battery configured to supply a power, a camera, a sound output module (e.g., a receiver, a speaker, a buzzer, etc.), and a communication module.

In some exemplary embodiments of the present disclosure, the display unit may include at least one of an LCD (Liquid Crystal Display), a TFT-LCD (Thin Film Transistor-Liquid Crystal Display), an OLED (Organic Light Emitting Diode), a flexible display and a 3 dimensional (3-D) display.

In some exemplary embodiments of the present disclosure, the microscope camera may include a lens unit including a plurality of lenses for enlarging an object, an illumination unit for illuminating the object, a camera module configured to receive an enlarged light image of an object from the lens unit, convert the image to an electrical signal and convert the electrical signal to a DC data, and an interface unit configured to connect the camera module to a mobile terminal for transmitting the DC data to the mobile terminal.

In some exemplary embodiments of the present disclosure, the camera module may include an infra-red filter configured to interrupt an infra-red from the enlarged image of the object and to send an infra-red interrupted optical image to an image sensor, the image sensor configured to convert the infra-red interrupted optical image to an electrical signal, and a slave controller configured to convert the electrical signal of the image sensor to a DC data and to send the DC data to a mobile terminal.

In some exemplary embodiments of the present disclosure, the interface unit may be a USB interface configured to be connected to the mobile terminal via a USB cable.

In some exemplary embodiments of the present disclosure, the slave controller may be a USB slave controller configured to output a USB slave mode signal and convert a parallel data to a series data.

In some exemplary embodiments of the present disclosure, the camera module may further include at least one of a power controller configured to supply a power to the camera module or control the power supply, a synchronized signal generator configured to generate a synchronized signal, and memory configured to store an image data digitalized by the image sensor or the parallel data converted by the slave controller.

In some exemplary embodiments of the present disclosure, the illumination unit may include at least one LED (Light Emitting Diode).

In some exemplary embodiments of the present disclosure, the camera further comprises an image capture button capable of capturing an object.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic view of a microscope camera according to an exemplary embodiment of the present disclosure;

FIG. 2 is a block diagram illustrating a camera module connected to a mobile terminal according to an exemplary embodiment of the present invention;

FIG. 3 is a flowchart illustrating an operation of a camera module connected to a mobile terminal according to an exemplary embodiment of the present invention; and

FIG. 4 is a flowchart illustrating an operation of a mobile terminal connected to a camera module according to an exemplary embodiment of the present invention;

### DETAILED DESCRIPTION

The suffixes ‘module’ and ‘unit’ may be used for elements in order to facilitate the disclosure. Significant meanings or roles may not be given to the suffixes themselves and it is understood that the ‘module’ and ‘unit’ may be used together or interchangeably.

Hereinafter, exemplary embodiments of the present disclosure are described in detail with reference to the accompanying drawings. In the drawings, sizes or shapes of constituent elements may be exaggerated for clarity and convenience.

Particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

The description of the various embodiments is to be construed as exemplary only for illustrative purposes, and does not describe every possible instance of the disclosure. Therefore, it should be understood that various changes may be made and equivalents may be substituted for elements of the disclosure.

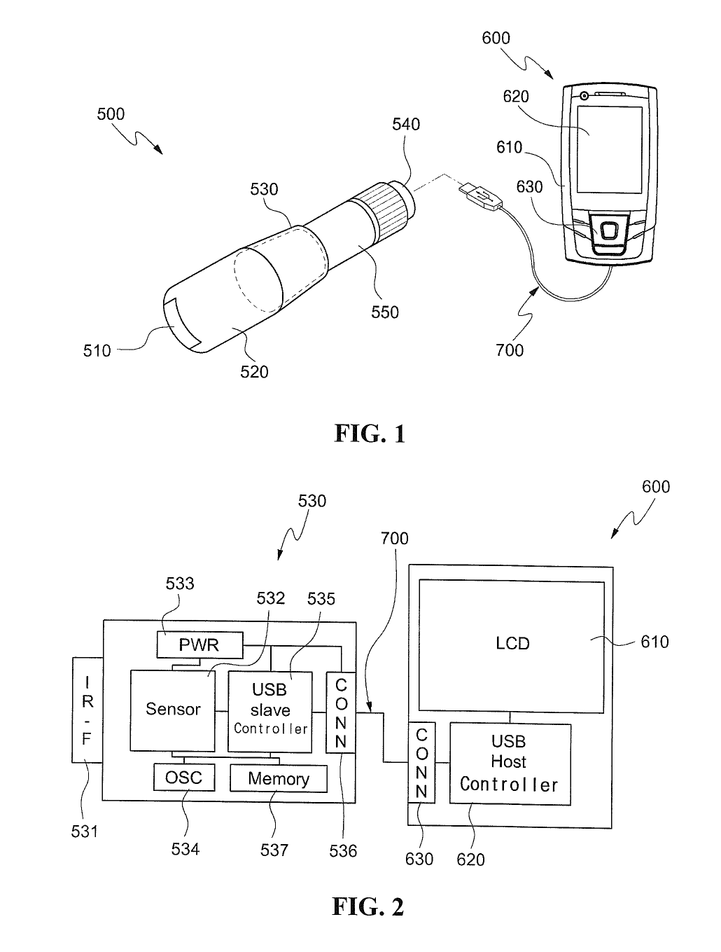

FIG. 1 is a schematic view of a microscope camera according to an exemplary embodiment of the present disclosure.

Referring to FIG. 1, a microscope camera 500 according to the exemplary embodiment of the present disclosure may include a lens unit 510, a body tube 520, a camera module 530, an interface unit 540 and an illumination unit 550.

The microscope camera 500 may be connected to a mobile terminal via a connection cable 700 to output an image that has enlarged an object. The connection cable 700 may be a USB cable, and the interface unit 540 may be a USB interface unit in a case the USB cable is used.

The mobile terminal may include all types of hand-held wireless communication devices, such as, for example, a PCS (Personal Communication System), a GSM (Global System for Mobile communication), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), and a Wibro (Wireless Broadband Internet).

A mobile terminal 600 may include a display unit 620 mounted in front of a body 610 for displaying information, and an input unit 630 for inputting the information.

A body 610 which is a case forming an exterior area of the mobile terminal 600 may be formed in one body, or may be formed in a plurality of bodies, each body interchangeably opened and closed. The body 610 may further include a battery configured to supply a power, a camera 12, a sound output module (14. e.g., a receiver, a speaker, a buzzer, etc.), and a communication module.

The display unit may include at least one of an LCD (Liquid Crystal Display), a TFT-LCD (Thin Film Transistor-Liquid Crystal Display), an OLED (Organic Light Emitting Diode), a flexible display and a 3 dimensional (3-D) display.

The lens unit 510 may include a plurality of lenses for enlarging an object, and an optical image from the object receives light from the lens unit 510, where the light passes the body tube 520 to be transmitted to the camera module 530, and converted to an electrical signal via an image sensor 532 of the camera module 530. The camera module 530 may be a camera module using a CCD (Charge Coupled Device) or a CMOS (Complementary metal-oxide-semiconductor) image sensor.

The electrical signal is transmitted through a cable 700 connected to the interface unit 540 to be outputted in an enlarged image on the display unit 610 of the mobile terminal 600. The illumination unit 550 may include, for example, an LED which can apply an amount of light increased as much as a predetermined level over that provided during a naked eye observation, whereby an object can be more vividly and clearly captured.

The microscope camera 500 may be provided at one side thereof with an image capture button (not shown) configured to capture an object. The microscope camera 500 may be connected to a base and used in a fixed manner.

Although the present exemplary embodiment of the present disclosure has used a USB protocol for connecting a mobile terminal to a microscope camera, the configuration is just an example and is not limited thereto. It should be apparent to those skilled in the art that various protocols other than the USB protocol may be also used.

FIG. 2 is a block diagram illustrating a camera module connected to a mobile terminal according to an exemplary embodiment of the present invention.

Referring to FIG. 2, the camera module may include an infra-red filter 531, an image sensor 532, a power controller 533, a synchronized signal generator 534, a slave controller 535, a connector 536 and a memory 537.

The infra-red filter 531 may interrupt an infra-red from a received optical image and send the infra-red-removed image to the image sensor 532. The image sensor 532 may be, for example, a CCD (Charge Coupled Device) image sensor 532 or a CMOS (Complementary metal-oxide-semiconductor) image sensor 532, and convert the irradiated optical image to an electrical signal.

The power controller 533 may supply a power supplied from the mobile terminal 600 to an inside of the camera module 530 and control the power, in a case the mobile terminal 600 is connected to the camera module 530 via the connection cable 700.

The synchronized signal generator 534 may generate a reference generating V-sync and H-sync of the image sensor 532, and a synchronization signal for a serial communication of the slave controller 535, and supply a reference clock during a serial storage in the memory 537.

The slave controller 535 is a controller configured to transmit a serial data which is an image data of the camera module 530, from the camera module 530 to the mobile terminal 600. The slave controller 535 may output a USB slave mode signal in a case the connection cable 700 is inserted into the mobile terminal 600, and it is preferable that a USB slave controller configured to convert a parallel data to a serial data be used.

The connector 536 may connect a signal line between the camera module 530 and the mobile terminal 600. The memory 537 may store an image data digitalized by the image sensor 532, or store a parallel data converted from the slave controller 535. The connector 536 of the camera module 530 may be connected to connector 630 of the mobile terminal 600 via the connection cable 700. The mobile terminal 600 may output the received image data to the display unit 610.

For example, the image data received by the mobile terminal 600 is stored in a display memory (not shown), and data in the display memory is transmitted to an OS (Operating System) capable of JAVA application to be outputted to the display unit 610 in a JAVA viewer type, or to capture a photo desired by a user. Furthermore, the user may transmit the photo captured by the mobile terminal 600 to other mobile terminals.

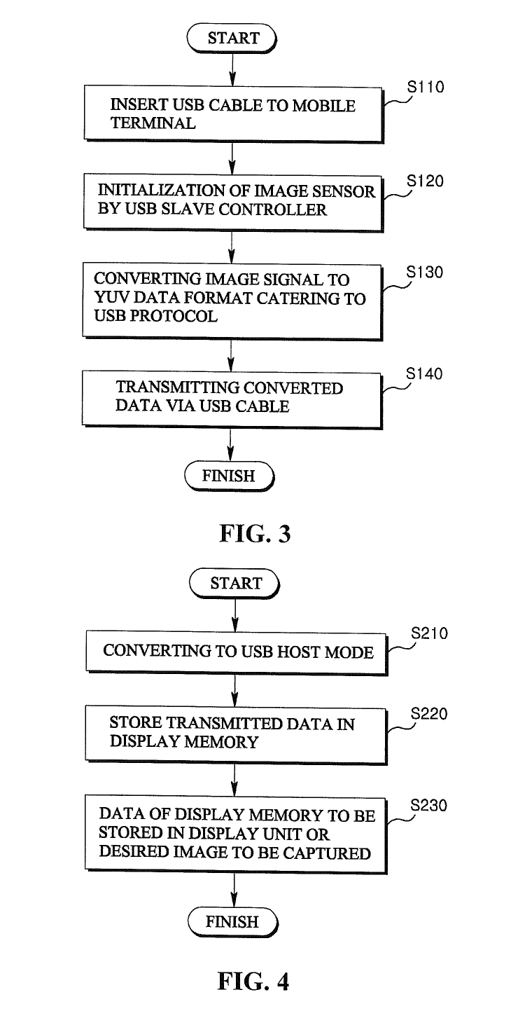

FIG. 3 is a flowchart illustrating an operation of a camera module connected to a mobile terminal according to an exemplary embodiment of the present invention.

Referring to FIG. 3, the connection cable 700 is inserted into the mobile terminal 600 (S110). The image sensor 532 is initialized by the slave controller 535 (S120). At this time, the camera module 530 may transmit the USB slave mode signal to the mobile terminal 600.

The image signal from the image sensor 532 is converted to YUV data format to cater to USB protocol (S130). The converted data is transmitted to the mobile terminal 600 connected via the USB cable 700 (S140).

FIG. 4 is a flowchart illustrating an operation of a mobile terminal connected to a camera module according to an exemplary embodiment of the present invention.

Referring to FIG. 4, in a case the USB slave mode signal is received from the camera module 530, the USB slave mode signal is converted to USB host mode (S210). The USB host mode is a mode outputted by storing, manipulating the data received from the camera module 530 via the connection cable 700, or outputting the data via the display unit 610. The data received via the connection cable 700 is stored in the display memory (S220).

The data of the display memory is outputted to the display unit 610 using a JAVA application program (S230). The user may capture a desired image using the JAVA application program for storage in the memory. Thereafter, the user may transmit the captured image to other mobile terminals or a computer.

Although the present disclosure has used the JAVA application program for outputting an image data onto a display unit or capturing the image, the present exemplary embodiment is illustrative only, and it should be apparent to those in the skilled in the art that various programs other than the JAVA application program may be used.

The above-mentioned microscope camera and mobile terminal using the same according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A microscope camera is provided, the camera comprising: a lens unit including a plurality of lenses for enlarging an object; an illumination unit for illuminating the object; a camera module configured to receive an enlarged light image of an object from the lens unit, convert the image to an electrical signal, and convert the electrical signal to a DC data; and an interface unit configured to connect the camera module to a mobile terminal for transmitting the DC data to the mobile terminal.

2. The camera of claim 1, wherein the camera module includes an infra-red filter configured to interrupt an infra-red from the enlarged image of the object and to send an infra-red interrupted optical image to an image sensor, the image sensor configured to convert the infra-red interrupted optical image to an electrical signal, and a slave controller configured to convert the electrical signal of the image sensor to a DC data and to send the DC data to a mobile terminal.

3. The camera of claim 1, wherein the interface unit is a USB interface configured to be connected to the mobile terminal via a USB (Universal Serial Bus) cable.

4. The camera of claim 2, wherein the slave controller is a USB slave controller configured to output a USB slave mode signal and convert a parallel data to a series data.

5. The camera of claim 2, wherein the camera module includes at least one of a power controller configured to supply a power to the camera module or control the power supply, a synchronized signal generator configured to generate a synchronized signal, and memory configured to store an image data digitalized by the image sensor or the parallel data converted by the slave controller.

6. The camera of claim 2, wherein the mobile terminal receives a USB slave mode signal from the camera module, and stores, manipulates, or displays the signal through a display unit.

7. The camera of claim 1, wherein the mobile terminal is a PCS (Personal Communication System), a GSM (Global System for Mobile communication), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), and a Wibro (Wireless Broadband Internet).

8. The camera of claim 1, wherein the illumination unit includes at least one LED (Light Emitting Diode).

9. The camera of claim 1 further comprising an image capture button capable of capturing an object.

10. A mobile terminal having a microscope camera, comprising: a body; a display unit configured to display information on the body; and a microscope camera connected to the body via a connection cable for allowing an enlarged image of the object to be displayed on the display unit or capturing an object image.

11. The mobile terminal of claim 10, wherein the body includes at least one of a battery configured to supply a power, a camera, a sound output module (e.g., a receiver, a speaker, a buzzer, etc.), and a communication module.

12. The mobile terminal of claim 10, wherein the display unit includes at least one of an LCD (Liquid Crystal Display), a TFT-LCD (Thin Film Transistor-Liquid Crystal Display), an OLED (Organic Light Emitting Diode), a flexible display and a 3 dimensional (3-D) display.

13. The mobile terminal of claim 10, wherein the microscope camera includes a lens unit including a plurality of lenses for enlarging an object, an illumination unit for illuminating the object, a camera module configured to receive an enlarged light image of an object from the lens unit, convert the image to an electrical signal and convert the electrical signal to a DC data, and an interface unit configured to connect the camera module to a mobile terminal for transmitting the DC data to the mobile terminal.

14. The mobile terminal of claim 13, wherein the camera module includes an infra-red filter configured to interrupt an infra-red from the enlarged image of the object and to send an infra-red interrupted optical image to an image sensor, the image sensor configured to convert the infra-red interrupted optical image to an electrical signal, and a slave controller configured to convert the electrical signal of the image sensor to a DC data and to send the DC data to a mobile terminal.

15. The mobile terminal of claim 13, wherein the interface unit is a USB interface configured to be connected to the mobile terminal via a USB cable.

16. The mobile terminal of claim 14, wherein the slave controller is a USB slave controller configured to output a USB slave mode signal and convert a parallel data to a series data.

17. The mobile terminal of claim 14, wherein the camera module further includes at least one of a power controller configured to supply a power to the camera module or control the power supply, a synchronized signal generator configured to generate a synchronized signal, and memory configured to store an image data digitalized by the image sensor or the parallel data converted by the slave controller.

18. The mobile terminal of claim 13, wherein the illumination unit includes at least one LED (Light Emitting Diode).

19. The mobile terminal of claim 13, wherein the camera further comprises an image capture button capable of capturing an object.
